(19) United States
(12) Patent Application Publication
(10) Pub. No.: US 2014/0058862 A1
(43) Pub. Date: Feb. 27, 2014

(54) Secure Online Push Payment Systems and Methods

(71) Applicant: Nerijus Celkonas, San Jose, CA (US)

(72) Inventor: Nerijus Celkonas, San Jose, CA (US)

(21) Appl. No.: 13/655,706

(22) Filed: Oct. 19, 2012

Related U.S. Application Data
(60) Provisional application No. 61/693,715, filed on Aug. 27, 2012.

(51) Int. Cl. G06Q 20/20

(52) U.S. Cl. 705/18

(57) ABSTRACT

Some embodiments provide a payment system that involves mobile applications, merchant Points-of-Sale (POS's), and a back-end. The back-end registers a mobile application for use by a user and a user PIN to complete a transaction via the mobile application. The back-end also registers identifiers to uniquely identify the merchant POS's. The user performs a check-in to a merchant POS by submitting the unique encoded identifier of the merchant POS to the back-end using the mobile application. The merchant can then invoice the user by selecting the corresponding check-in of that user and uploading an invoice for that check-in to the back-end. The back-end provides the invoice to the user via the mobile application. The user enters his/her PIN in the mobile application to approve payment for the transaction and the back-end completes the transfer of funds from a user account to a merchant account.

### CLAIM OF BENEFIT TO RELATED APPLICATIONS

This application claims the benefit of U.S. provisional application 61/693,715, entitled “Secure Online Push Payment Systems and Methods”, filed on Aug. 27, 2012. The contents of application 61/693,715 are hereby incorporated by reference.

### TECHNICAL FIELD

The present invention relates to the fields of electronic payment processing.

### BACKGROUND ART

Credit cards are ubiquitous and universally accepted. In many ways, they are the de facto standard for completing financial transactions in the United States of America.

Credit cards represent a pull-based payment methodology. When a merchant “runs” a credit card using a credit card terminal, the terminal pulls a specified amount of funds from the credit card company and deposits those funds to an account of the merchant. The funds are borrowed from an amount of credit that is leant by the credit card company to the credit card user. At some later time (usually at the end of a monthly billing cycle), the credit card user reimburses the credit card company for the borrowed amount or pays interest to carry the outstanding debt over to another billing cycle.

The proliferation of credit cards can be attributed in large part to their convenience and widespread acceptance. Yet, credit cards come at a cost to both the user and the merchant.

For the merchant, the actual cost is manifested in the form of a transaction fee that the credit card company takes for each credit card transaction the merchant completes. A specified percentage of each sale completed using a credit card is taken from the merchant and passed to the credit card company. The percentage typically ranges from one to three percent of the transaction total. In many instances, the transaction fee is not limited by anything other the price of the transaction.

For the user, the actual cost is manifested in the form of annual fees to the credit card company and, more significantly, interest that is paid on outstanding debt. This interest typically averages around ten percent of the outstanding balance. The interest accrues each billing cycle.

Debit cards operate along a similar pull-based payment methodology, although the merchant that runs the debit card pulls a specified amount of funds directly from a bank account of the card owner. Merchants are not charged the same percentage transaction fees when debit cards are used to complete a transaction. Instead, a small fixed fee is charged irrespective of the transaction amount. As a result, debit cards are preferred by many merchants. Also, there is usually no actual cost to the user as payment is made from the funds in the user's back account such that the user does not incur debt on which interest can be charged. Accordingly, debit cards are an alternative form of a pull-based payment method.

While transactions completed using debit cards do not experience the same actual costs as transactions completed using credit cards, each of these pull-based payment methodologies suffers from significant inherent costs. The primary inherent cost stems from the lack of security and the relative ease with which fraud can be perpetrated on a user or merchant when using a pull-based payment methodology. For instance, credit card or debit card transactions can be completed on behalf of another online with nothing more than a credit card number and basic identification information. The card itself is not needed to complete an online transaction. For example, one can purchase a good from an online merchant by providing the merchant a stolen credit card number, security code (usually found on the back of the credit card), and name of the credit card holder or a stolen debit card number and PIN. Should the card holder uncover the fraudulent activity, laws ensure that the card holder is not liable for the fraudulent transactions. Nevertheless, the convenience of these cards is severely compromised as the user must first spot the fraudulent activity, dispute the activity by reporting it to a card issuer, and await the resolution of the disputed charges before being refunded the funds. The merchant undergoes an even tougher challenge to recover goods or funds provided as a result of fraud perpetrated by a customer.

Even with these costs and risks, pull-based payment methods remain in widespread usage and are even being adapted for new technology. For instance, Near Field Communication (NFC) integration in smartphones is now enabling credit card payment by simply waving a smartphone in range of an NFC enabled credit card terminal.

The alternative to pull-based payment methods are push-based payment methodologies. A push-based transaction differs from a pull-based transaction in that it is initiated by the user/customer and not the merchant. Push-based transactions are most readily manifested as wire transfers in which a user initiates a transfer of funds from his account to an account of another. The actual costs for these transactions are insignificant, often ranging from a few cents to a few dollars for large transfers. Security however remains a concern.

In many push-based payment methodologies, a user sets up a profile using an email address and links a bank account to the profile. Funds can then be electronically sent and received from the linked bank account by simply specifying an amount and an email address of another user with a registered profile that is also linked to a bank account. Here again, the shortcomings of the payment methodology lie in the lack of security. By gaining access to one's username and password, funds can be wired out of the user's account. Like online credit card payments, anyone from anywhere can transfer funds from an account that is linked to a push-based profile to another account that is linked to another push-based profile.

Accordingly, there is a need for improved payment methodology. Specifically, there is a need for a payment methodology like existing push-based payment methodologies that do not impose high transaction actions, that provide the convenience of use of pull-based payment methodologies, but that also provide better security mechanisms to thwart the potential for fraudulent activity.

### SUMMARY OF THE INVENTION

It is an objective of the embodiments described herein to provide a payment system that retains the convenience of traditional pull-based payment methodologies and the low cost of traditional push-based payment methodologies, while providing added security to prevent fraud. To this end, some embodiments provide secure push-based payment system and methods for safely wiring funds from one payment account to another payment account remotely using a mobile device. The system and methods facilitate the completion of a transaction through concerted action by users and merchants, thereby eliminating the ability for a single party to entirely control the transaction.

The payment system comprises a plurality of mobile applications, merchant Points-of-Sale (POS's), and a back-end. The back-end registers profiles for each user and merchant participating in the payment system. Users and merchants link at least one bank or other payment account to the profile. Additionally, the back-end registers a mobile application for use by one or more mobile devices of the user as well registering a PIN to complete a transaction via the mobile application. As a result, the user is protected with several security layers. The first layer requires the user to provide authentication credentials to access the mobile application. The second layer verifies that the mobile application is run on a mobile device that is connected to the user profile. The third layer requires the PIN to be entered in order to complete payment for a transaction.

The back-end also registers the merchant POS's to provide yet another security layer. The merchant POS serves as the identifier by which the user and merchant each securely enter into a transaction. First, the user checks-in to a merchant POS. This is accomplished when the user is at the merchant storefront where one or more registered POS's are presented. The user securely logs in and accesses the mobile application. Using the mobile application, the user performs a check-in to a merchant POS by submitting the unique encoded identifier of the presented POS to the back-end. The back-end notifies the merchant of the check-in. The merchant can then invoice the user by selecting the corresponding check-in of that user and uploading an invoice for that check-in to the back-end. The back-end provides the invoice to the user via the mobile application. When the user approves and wishes to pay for the transaction, the user enters his/her PIN in the mobile application. The mobile application notifies the back-end of the confirmation and the back-end completes the transfer of funds from the user account to the merchant account. This concerted set of actions ensures that no one party to a transaction can initiate and complete a transaction without engagement by the other party to the transaction.

### BRIEF DESCRIPTION OF THE DRAWINGS

In order to achieve a better understanding of the nature of the present invention, preferred embodiments for the secure push-based payment system and methods will now be described, by way of example only, with reference to the accompanying drawings in which:

FIG. 1 provides an overview of the payment system and a description for the methodology of completing a transaction using the system in accordance with some embodiments.

FIG. 2 presents a flow diagram conceptually illustrating how a transaction is initiated and completed using the payment system in accordance with some embodiments.

FIG. 3 presents a registration interface for creating a new user profile in accordance with some embodiments.

FIG. 4 presents a PIN entry interface in accordance with some embodiments.

FIG. 5 presents an exemplary home page illustrating five accounts that have been linked to a user profile.

FIG. 6 presents an exemplary login interface in accordance with some embodiments.

FIG. 7 presents an exemplary mobile application home interface in accordance with some embodiments.

FIG. 8 illustrates an exemplary “History” interface displaying a transaction history for a user account in accordance with some embodiments.

FIG. 9 illustrates an exemplary check-in interface that is in accordance with some embodiments.

FIG. 10 presents a check-in confirmation interface in accordance with some embodiments.

FIG. 11 illustrates an exemplary detailed transaction interface for a Check-In transaction in accordance with some embodiments.

FIG. 12 presents an exemplary external transaction generation interface.

FIG. 13 presents an exemplary WebPay transaction interface for accepting or declining an online transaction using the mobile application in accordance with some embodiments.

FIG. 14 illustrates an interface with which to request money from other participants using the mobile application in accordance with some embodiments.

FIG. 15 presents an interface with which a user can specify other users to share an account with and the corresponding limits and restrictions placed on the shared account.

FIG. 16 illustrates an exemplary interface for managing existing POS's and adding new POS's in accordance with some embodiments.

FIG. 17 illustrates a POS creation interface in accordance with some embodiments.

FIG. 18 presents a process by which a merchant invoices a user based on a check-in by the user to a POS of the merchant.

FIG. 19 presents a process for completing a transaction using an instance of the mobile application that runs on a network enabled device of a merchant in accordance with some embodiments.

FIG. 20 presents a process performed by the back-end to register a user profile in accordance with some embodiments.

FIG. 21 presents a process performed by the back-end to register a merchant profile in accordance with some embodiments.

FIG. 22 presents a process performed by the back-end to complete a transaction in accordance with some embodiments.

FIG. 23 illustrates a computer system or server with which some embodiments are implemented.

### DETAILED DESCRIPTION

In the following detailed description, numerous details, examples, and embodiments for the secure push-based payment system and methods are set forth and described. As one skilled in the art would understand in light of the present description, these system and methods are not limited to the embodiments set forth, and these system and methods may be practiced without some of the specific details and examples discussed. Also, reference is made to the accompanying figures, which illustrate specific embodiments in which the system and methods can be practiced. It is to be understood that other embodiments can be used and structural changes can be made without departing from the scope of the embodiments herein described.

To facilitate the discussion that is to follow, user refers to a customer of a merchant. The user is any entity that purchases or otherwise acquires a good or service from the merchant for a fee with the merchant acting as the seller of that good or service. The merchant can include any traditional storefront business as well as an online retailer.

Mobile device refers to any network enabled communication device that is capable of running one or more applications. A network enabled communication device includes a device that offers network connectivity to a digital network such as the Internet. The network connectivity can be facilitated through a wireless or wired medium. Accordingly, a mobile device envisioned for use with the secure push-based payment system and methods described herein includes any smartphone, tablet, or laptop device that has WiFi, 3G, or 4G (e.g., LTE, HSPA+, etc.) wireless connectivity.

The term account is used in reference to a bank account or other payment account to which funds can be electronically deposited and from which funds can be electronically withdrawn. This includes any account that can be linked to a debit card or any account that is compatible with existing wire transfer deposits and debits.

### I. Overview

Some embodiments provide a secure push-based payment system and methods. These system and methods overcome the security shortcomings of existing pull-based and push-based payment methodologies while still providing a convenient payment methodology that is preferred by users and merchants alike because of its low transaction processing fees. The secure push-based payment system and methods enable a transfer of funds from one bank account to another bank account, similar to a wire transfer, but with the added security of requiring a concerted and independent interaction by the transferor and the transferee to complete the transaction. In this manner, no single party to a transaction can initiate and complete the transaction without knowledge and active engagement of the other party to the transaction. Security mechanisms included in the system and methods of some embodiments also ensure that the transferee is unable to act on behalf of the transferor and that the transferor is similarly unable to act on behalf of the transferee, thereby thwarting the potential for fraud.

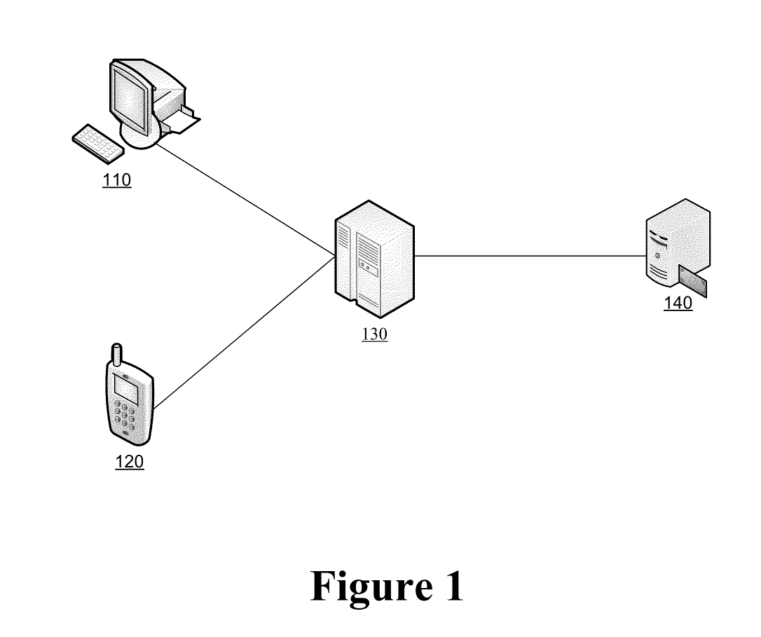

FIG. 1 provides an overview of the payment system and a description for the methodology of completing a transaction using the system in accordance with some embodiments. The system depicts a merchant Point-of-Sale (POS) 110, a mobile application 120, and a payment system back-end 130 (hereinafter back-end 130).

The POS 110 is provided by a merchant at any location in which the merchant engages in a transaction with a user. The POS 110 can be transitory if the merchant is transitory or can be stationary if the merchant has a traditional storefront location that is visited by users interested in completing a transaction with the merchant. The POS 110 serves to securely identify the transaction between the merchant and the user. The POS 110 provides a unique encoded identifier that the back-end 130 generates and associates to the merchant. In some embodiments, the POS 110 is an alphanumeric value, bar code, QR code, or any other visual representation that can be displayed by the merchant for use by the user. The POS 110 facilitates a secure transaction by requiring that both the merchant and user independently identify the unique encoded identifier when completing a transaction through the back-end 130. Though one POS 110 is illustrated in this figure, it will become apparent later in the discussion that the back-end 130 support thousands of POS's at any given instance. The back-end 130 generates and associates one or more POS's to each merchant that participates in the payment system. A merchant registers multiple POS's with the back-end 130 when the merchant has multiple points at which it completes transactions with users. This may include designating each cash register operated by the merchant as a POS or may include designating each table at a restaurant as a POS as some examples.

The mobile application 120 is software running on any network enabled mobile device of a user engaging in a transaction with the merchant. Specifically, the mobile application 120 is stored as a set of computer program instructions on a non-transitory computer-readable storage medium of a mobile device having at least one processor capable of executing the computer program instructions. The mobile application 120 provides the convenient and secure interface for the user to complete any transactions that are conducted with the merchant. The mobile application 120 facilitates the payment of fees to the merchant by displaying merchant invoices to the user, receiving confirmation from the user that the invoices are indeed correct, and securely communicating with the back-end to transfer funds from a user payment account to a merchant payment account. In this manner, the mobile application 120 replaces traditional credit cards, debit cards, and other cards that can be easily used to commit fraud. The security features of the mobile application 120 include requiring a secure login before the mobile application 120 can be accessed, verifying that the mobile device on which the mobile application 120 runs is authorized to access the user profile or payment accounts, requiring the user to identify a unique encoded identifier that is associated with a POS of the merchant (i.e., POS 110) before a transaction can be completed with the merchant, and requiring a Personal Identification Number (PIN) before the transaction can be completed. These security features compliment existing security features of the user's mobile device which may include a secure lock screen. In other words, the mobile application 120 provides the necessary interface by which a user can engage and complete a transaction with a merchant and the back-end 130 independent of the interactions performed by the merchant to engage and complete the transaction. Thus, the mobile application 120 transforms the user's mobile device to a specially purposed device that facilitates the push based payment system as set forth herein.

The back-end 130 provides the interworking between the users, merchants, and one or more banks 140 hosting the payment accounts that contain the funds of the users and merchants. Specifically, the back-end 130 performs the registration of users and merchants to generate profiles for identifying the users and merchants in the payment system. As part of the registration, the back-end 130 links bank or payment accounts to the profiles of the users and merchants. Also as part of the registration, the back-end 130 authorizes the use of mobile applications with user profiles as well as generating and tracking the POS's for the merchants.

To facilitate a transaction with the merchant operating the POS 110, the mobile application 120 checks-in with the back-end 130 by providing the back-end 130 the unique encoded identifier of the POS 110. The back-end 130 notifies the merchant of the check-in at the POS 110. The merchant submits invoicing for the check-in at the POS 110 to the back-end 130 which forwards the invoice to the mobile application 120 that performed the check-in at the POS 110. The user then confirms or declines payment for the invoice and the mobile application 120 communicates the user selection to the back-end 130 which can then perform the transfer of funds when the user confirms the transaction. In this manner, the back-end serves as a clearing house to ensure funds are securely transferred from an account of one party to a transaction to another party of the transaction by performing the transfer only when the above described security features have been meet and a transaction is deemed complete.

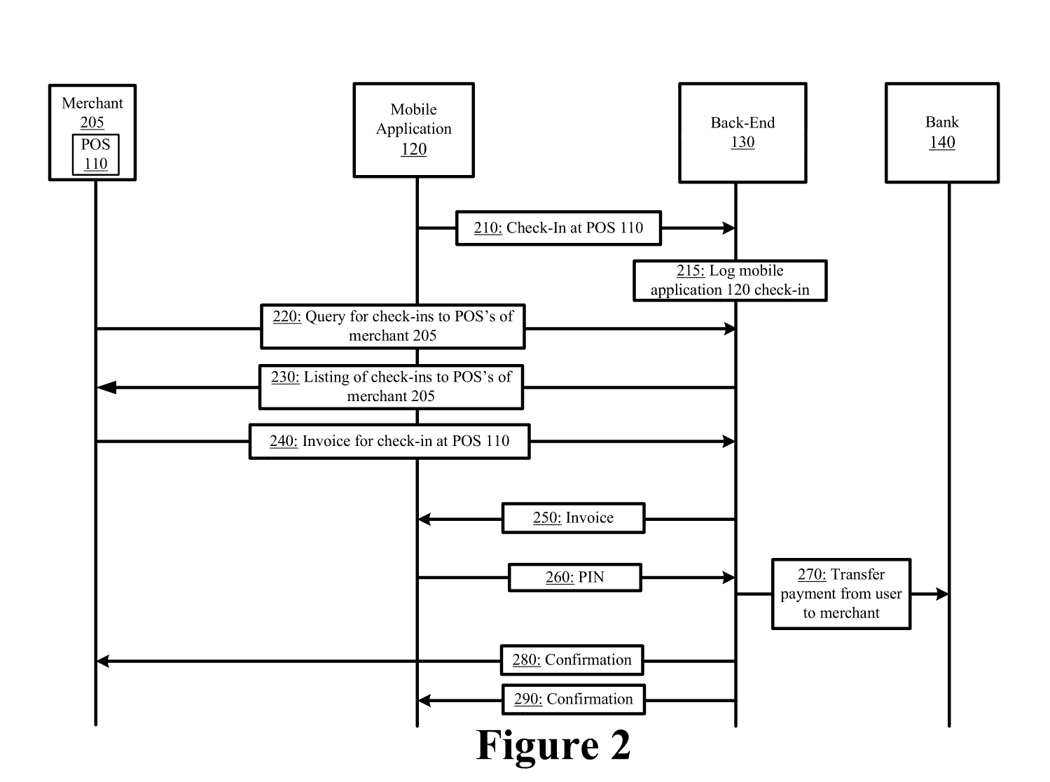

As noted above, unlike pull-based payment methodologies whereby the merchant initiates and completes a transaction and unlike push-based payment methodologies whereby the user initiates and completes a transaction, the described payment system of some embodiments requires concerted action by both the user and the merchant to ensure a secure transaction. FIG. 2 presents a flow diagram conceptually illustrating how a transaction is initiated and completed using the payment system in accordance with some embodiments. As shown, the transaction involves the merchant 205 operating POS 110 of FIG. 1, mobile application 120, back-end 130, and bank 140.

To initiate a transaction, the user checks-in using the mobile application 120. The check-in involves the mobile application 120 submitting (at 210) to the back-end 130 an encoded unique identifier which is obtained from the POS 110 of the merchant 205 at which the transaction takes place. In some embodiments, the POS 110 includes an alphanumeric value, a bar code, or a QR code that provide different representations for the unique encoded identifier. The POS 110 is typically located at the merchant 205 location adjacent to where the merchant 205 performs its transactions. As one example, the POS 110 can be located adjacent to one of several registers of the merchant such that the encoded unique identifier identifies that specific register from other registers, with each of the other registers presenting a different encoded unique identifier represented by a different POS. As another example, the POS 110 can be located on a table of several restaurant tables when the merchant is a restaurateur. In this scenario, the encoded unique identifier for the POS 110 uniquely identifies the table at which the user sits and dines. The POS 110 can be presented on any tangible medium (e.g., paper, screen display) and displayed adjacent to the desired merchant location.

To obtain the encoded unique identifier of the POS 110, the user can manually enter the alphanumeric value of the POS 110 as input to the mobile application 120. Alternatively, when the POS 110 is represented as a bar code or QR code, the mobile application 120 can initialize a camera on the mobile device that runs the mobile application 120. The camera snaps an image of the POS 110 and loads the image in the mobile application 120.

To complete the check-in, the mobile application 120 passes the mobile application identifying information with the encoded unique identifier of the POS 110 to the back-end 130. The mobile application 120 identifying information may include an identifier associated with the mobile application 120 itself or an identifier associated with the mobile device on which the mobile application 120 runs. This identifier can include, for example, the telephone number of the mobile device, an Internet Protocol (IP) address, or an International Mobile Subscriber Identity (IMSI).

Check-in can be performed as soon as the user enters the merchant location, for example, when the user is seated at a restaurant table. In this instance, the user checks-in prior to the transaction being completed. Alternatively, the check-in can be performed when the user is ready to complete a transaction with the merchant, for example, when the user arrives at a merchant register with goods that the user wishes to purchase.

The back-end 130 receives the user check-in via the mobile application 120. The back-end 130 logs (at 215) the check-in. More specifically, the back-end 130 identifies the merchant 205 that registered the POS 110. The back-end 130 then associates the check-in at POS 110 with the profile of the merchant 205. In some embodiments, associating the check-in with the profile of the merchant 205 involves entering the check-in in a pending transaction queue of the merchant. The pending transaction queue identifies those transactions or user check-ins that are awaiting action by the merchant 205. In some embodiments, the back-end 130 also logs the identifier (e.g., IP address) for the mobile application 120 that was provided as part of the check-in. This identifier is necessary to allow the back-end 130 to subsequently reconnect with the mobile application 120 when the merchant 205 submits an invoice that is to be forwarded back to the mobile application 120.

The merchant 205 queries (at 220) the back-end 130 for user check-ins to any of the POS's (including POS 110) registered to the merchant 205. The back-end 130 responds by providing (at 230) the merchant 205 with a list of check-ins to any POS of the merchant 205. In this example, the back-end 130 notifies the merchant 205 of the check-in to POS 110 which was performed by the user of the mobile application 120 at step 210. In some embodiments, the back-end 130 provides additional information regarding the check-in so that the merchant 205 can better identify the user that performed the check-in. This may include providing the merchant 205 with the name of the user, time of the check-in, etc. Such information may be obtained from a user profile to which the mobile application 120 is registered to.

To invoice the user that checked-in to POS 110, the merchant 205 selects the check-in identifying POS 110. Next, the merchant 205 submits (at 240) to the back-end 130, an invoice for the selected check-in to the POS 110. The merchant 205 submits the invoice when the transaction with the user is complete and the merchant 205 requests payment for the transaction. At a minimum, the invoice specifies a balance or amount that the merchant requests from the user and the check-in or POS identifier that the invoice is for. The invoice may also detail the transaction including listing goods and services that were provided as part of the transaction as well as information about the merchant, such as the merchant name, address, and other identifying information. The merchant 205 interactions with the back-end 130 during steps 220-240 occur through a series of website interfaces with the merchant 205 operating a web browser as a client device that renders the interfaces hosted by the back-end 130 server. The merchant 205 may also perform the interactions through a mobile application or a sales terminal or register.

The back-end 130 downloads (at 250) the invoice to the mobile application 120 using the identifier it logged when the mobile application 120 performed the check-in. As noted above, the invoice includes at least the amount that is requested from the user. Additionally, the invoice may include details regarding the transaction as well as identifying information about the merchant 205.

The mobile application 120 receives and displays the invoice as a pending transaction. Using the mobile application 120, the user views the invoice and confirms that the balance and other information is correct. If the user approves the invoice, the user completes the transaction by submitting (at 260) his/her PIN to the back-end 130 using the mobile application 120. In some embodiments, the mobile application 120 also submits at least one identifier to identify the invoice being completed as well as an identifier identifying a user payment account from which the funds are to be withdrawn. In some embodiments, the identifier for the invoice can include a unique number that the back-end 130 assigns to the invoice or the encoded unique identifier for the POS 110 as some examples.

Upon receiving the PIN from the mobile application 120, the back-end 130 pushes (at 270) the funds specified in the invoice from the user account and deposits those funds to an account of the merchant. The account information for performing the transfer will be present in the profiles registered by the user and merchant when signing up to participate in the payment system. In some embodiments, the account information present in each of the user and merchant profile includes an account number, a routing number, SWIFT code, and verification data (e.g., PIN) as some examples.

Upon transfer of the funds and completion of the transaction, the back-end 130 provides (at 280) confirmation of the completed transaction to the merchant 205. The confirmation identifies the completed invoice and the credited funds to the account of the merchant 205. The merchant 205 receives the confirmation through a web interface to the back-end 130 or via email, text message, or other form of communication. The back-end 130 also provides (at 290) confirmation to the mobile application 120. In this instance, the confirmation identifies the completed invoice and the debited funds from the account of the user.

From this overview, several security features of this system should become apparent. The transaction cannot be completed remotely as a physical presence is required at the merchant site in order to obtain the encoded unique identifier for the POS identifying the transaction. The transaction requires concerted action by the user and the merchant, each of which independently engage in the transaction by different interactions. For instance, the merchant must login to its profile in order to submit the invoice to the user and the user must login through the mobile application in order to check-in and pay the invoice. Lastly to complete the transaction, one must know how to satisfy the security features of the mobile device and the mobile application including unlocking the mobile device, logging in to the mobile application, and entering the correct PIN. Accordingly, there are multiple security layers built in this secure push-based payment methodology to prevent fraudulent activity. These security features do not hinder the convenience by which the user pays for a transaction. In fact, this system provides the added convenience of not having to carry a credit card, debit card, or other payment card such that there is no fear of losing the card. The user need only carry the mobile device that is configured with the mobile application. If this device is lost or stolen, the aforementioned security features prevent fraudulent activity.

### II. Mobile Application

A. Registration

Users participate in the payment system by means of the mobile application running on a mobile device. The mobile application provides the same convenience of paying by credit card as the mobile device on which the mobile application runs is usually carried by the user wherever the user goes.

Before being able to pay for transactions using the mobile application, users register with the back-end to create a profile and link one or more bank or other payment accounts to the profile. Registration may occur from any network enabled device by directing a web browser to a landing page of the back-end, wherein the landing page provides a login interface and an option to register a profile in accordance with some embodiments.

From the landing page, a user with a registered profile can login to the profile using authentication credentials (i.e., username and password). Otherwise, the user invokes the “registration” link on the landing page in order to create a new profile. The back-end then presents a registration interface.

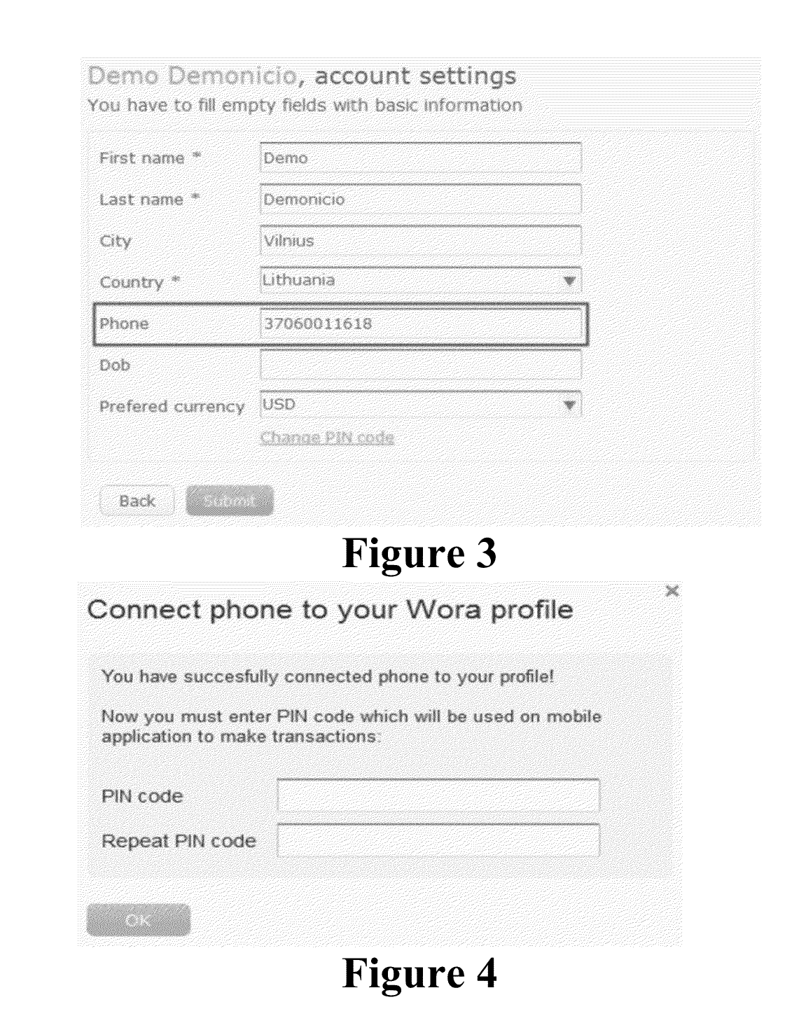

FIG. 3 presents a registration interface for creating a new user profile in accordance with some embodiments. As shown, the interface includes various fields in which the user enters identifying information. The identifying information includes the user name, address, etc. The identifying information also includes one or more telephone numbers of mobile devices that the user authorizes to have access to the user profile via the mobile application.

In some embodiments, the registered telephone number is an important security feature that prevents access to the profile and linked payment accounts of the user when the mobile application is run on a mobile device with a non-registered telephone number. To register a mobile device, the user logs in to his/her profile at the back-end. This log in can occur from any network enabled device with a web browser. The user then enters the telephone number for the mobile device he/she wishes to register for access to the profile. The back-end then generates a unique alphanumeric code that it sends via text or SMS message to the telephone number. If the user in fact operates the mobile device with the telephone number, the user obtains the code and returns the code to the back-end. The back-end then connects the mobile device having the registered telephone number to the user profile. The connected phone may then be used to run the mobile application and conduct transactions that debit and credit funds to the payment accounts linked to the user profile.

Whenever the mobile application launches on a mobile device, the mobile application first requests the user to provide authentication credentials (e.g., username and password) for access to a specific user profile. The mobile application passes the authentication credentials to the back-end. The mobile application also passes the telephone number of the mobile device on which the mobile application runs to the back-end. In some embodiments, the mobile application obtains the telephone number via one or more calls to the operating system of the mobile device.

The back-end determines if the credentials enable access to a specific user profile. If not, the back-end notifies the mobile application of the failed login and the user is requested to re-enter the authentication credentials. Otherwise, the back-end retrieves the profile accessed by the provided authentication credentials. The back-end then retrieves the list of telephone numbers for devices connected to the device. The back-end checks whether the telephone number for the mobile device currently being used to access the profile matches a telephone number of a connected device in the profile. If so, the back-end provides the mobile application with access to the user profile. Otherwise, the back-end prevents the mobile application from access to the user profile.

Some embodiments allow the mobile application to be run on a mobile device that does not have a telephone number. For example, a network enabled tablet may not have a telephone number assigned. In such cases, the device can be connected to the user profile using an identifier other than the telephone number. For example, an IMSI of the mobile device may be used to connect the device to the user profile.

Once the profile information has been provided and a phone is connected to the profile, registration continues with the back-end requesting that a PIN be specified for conducting transactions via the mobile device. In some embodiments, a single PIN may be used to pay for transactions using any payment account linked to the user profile. In some other embodiments, each payment account that is linked to the user profile is provided a different PIN for authorizing and paying for transactions. This again is another security feature of the payment system. Even if the user login information is compromised and the connected mobile device of the user is stolen, transactions still cannot be completed using the mobile application running on the stolen connected mobile device unless the proper PIN is provided. FIG. 4 presents a PIN entry interface in accordance with some embodiments.

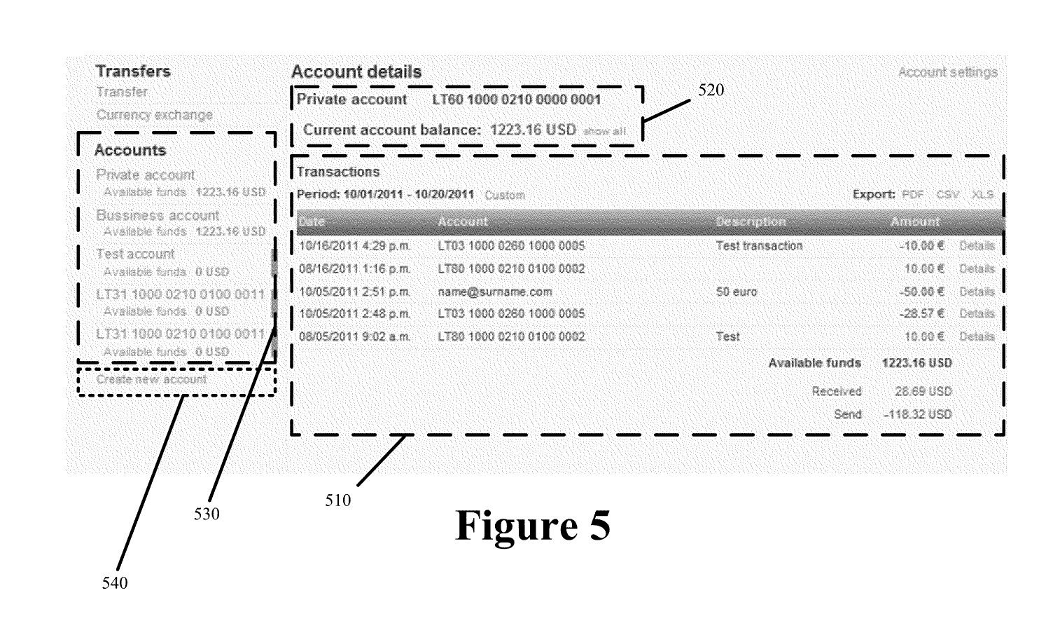

After entry of the PIN, the user is taken to a home page which shows accounts that the user has linked to his profile. FIG. 5 presents an exemplary home page illustrating five accounts that have been linked to a user profile. The home page provides summary information regarding the user profile. As shown in FIG. 5, the summary information includes a listing 510 of recent transactions conducted against a selected account 520. The user can switch between the accounts by selecting the desired account from the listing 530.

The home page will however display zero linked accounts for a newly registered user profile. The user can link one or more accounts to its profile by selecting the create new account link 540. Linking an account includes providing account identifying information and optionally verifying access to the account. In some embodiments, the account identifying information includes the account number as well as other information including a routing number, bank name, bank address, and Swift code as some examples. In some embodiments, verifying access to the account involves the back-end depositing a small amount into the identified user account so that the user has to access the account and report the deposited amount back to the back-end.

The home page thus provides the interface for managing the user profile including connecting additional mobile devices to the profile, managing accounts that are linked to the profile, and monitoring transaction conducted on each of the linked accounts. The foregoing is provided via a series of web interfaces (i.e., websites), though some embodiments permit registration to occur using the mobile application.

B. Mobile Application Home Interface

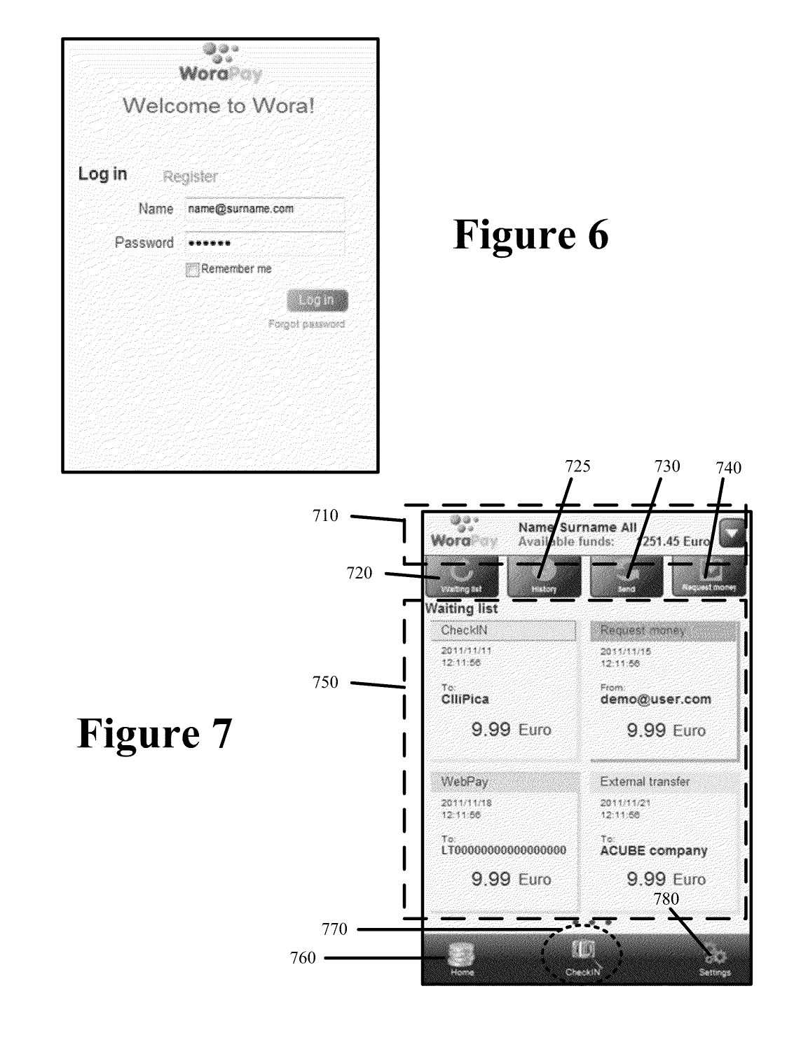

Upon completing registration, the mobile application can be used on any connected mobile device to conduct the secure push-based transactions. When the mobile application is launched on the mobile device, the user is presented with a login interface. FIG. 6 presents an exemplary login interface in accordance with some embodiments. This login interface accepts the user's authentication credentials that enable access to the registered user profile. As noted above, the mobile application in conjunction with the back-end will also verify that the mobile device being used is connected to the user profile during the login.

Once logged in, the mobile application displays a home interface. FIG. 7 presents in accordance with some embodiments an exemplary mobile application home interface. The home interface includes an account selection element 710, “Waiting List” element 720, “History” element 725, “Send” element 730, and “History” element 740, home interface view 750, and navigation elements 760, 770, and 780.

The accounts selection element 710 appears at the top of the screen and displays a selected account and the balance of that account. The user can switch between linked payment accounts by invoking this dropdown element. The home interface view 750 changes based on the selected account. Specifically, the home interface view 750 displays the transactions that are pending for the selected account. These include pending check-in transactions as described with reference to process 200 as well as other supported transaction types of the mobile application. For added use, the mobile application and the back-end support the ability to request money from other participants in the payment system, the ability to pay for an online web transaction without having to check-in, and the ability to perform a traditional wire transfer.

The home interface view 750 displays the pending transactions in a grid view with different coloration or highlighting to identify the different transaction types. The home interface view 750 presents the four most recent pending transactions for the selected account. Additional pending transactions can be accessed using iPhone style pagination.

Each transaction is displayed with summary information. For each displayed transaction, the summary information includes the time and date of the transaction, the other party involved in the transaction, and the transaction amount. Additional detail about the transaction can be obtained by selecting the graphical element for a desired transaction summary. In some embodiments, the additional detail includes an enumeration of the goods and services involved in the transaction (similar to a receipt or invoice that would ordinarily be exchanged to record the transaction). To this end, some embodiments allow merchants to upload detailed transactions for an invoice which are then displayed in the detailed transaction view on the mobile application.

The “Waiting List” element 720 returns the user to the home interface.

The “History” element 725 changes the interface to display transactions that have been completed using the selected account. The History interface thus differs from the home interface view which displays pending transactions that have yet to be completed. Specifically, the back-end tracks all transactions completed by a user. These transactions can be viewed in the mobile application by invoking the “History” element 725.

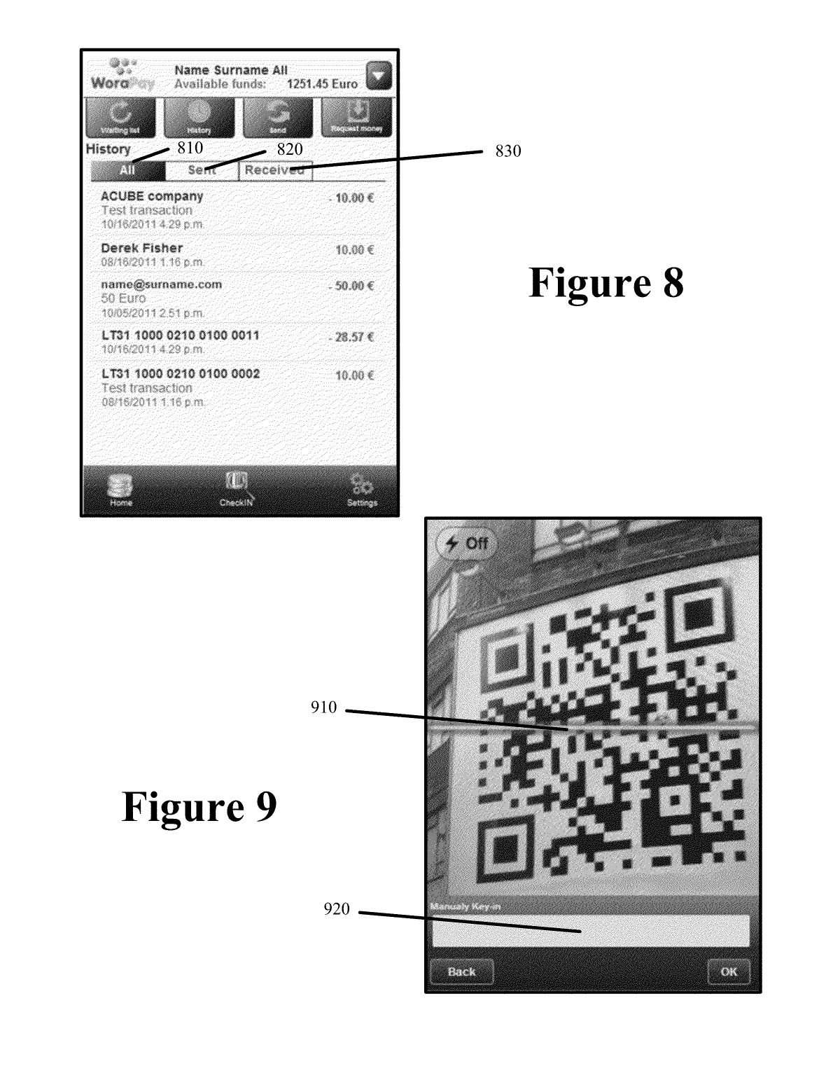

FIG. 8 illustrates an exemplary “History” interface displaying a transaction history for a user account in accordance with some embodiments. Each transaction in the History interface displays the name of the other party to the transaction, optional descriptive information, a timestamp the transaction was completed, and the amount of debit or credit associated with the transaction. The mobile application displays all completed transactions for the selected account in chronological order when the “All” button 810 is selected. The mobile application sorts the completed transactions for the selected account to display the debit transactions when the “Sent” button 820 is selected. The mobile application sorts the completed transactions for the selected account to display the credit transactions when the “Received” button 830 is selected. Scrolling within the history interface displays additional completed transactions that do not fit within a current display view.

With reference back to FIG. 7, the “Send” element 730 accesses an interface and functionality to perform traditional wire transfers using the mobile application in conjunction with the back-end. The “Request Money” element 740 accesses an interface and functionality to request funds from another participant in the payment system. Additional description for these additional supported transactions is provided below.

The navigation elements 760, 770, and 780 are static elements that appear on the bottom of the different mobile application interfaces. Invoking the navigation element 760 causes the mobile application to return to the home interface. Invoking the navigation element 770 causes the mobile application to perform a check-in as described in the section below. Invoking the navigation element 780 provides the user access to various profile settings.

C. Check-In Interface

An initial step in completing a transaction is the mobile application check-in. To perform a check-in, the user invokes the check-in navigation element 780. Invoking the check-in navigation element 780 causes the mobile application to display the check-in interface.

FIG. 9 illustrates an exemplary check-in interface that is in accordance with some embodiments. As shown, the check-in interface initializes the camera of the mobile device and a portion of the mobile device screen 910 is used as a viewfinder. Using the camera, the user can take a picture of a bar code, QR code, or other symbol representing an encoded unique identifier for a merchant POS. The check-in interface also includes text entry box 920 in which the user can manually enter an alphanumeric value for a POS. To complete the check-in, the user invokes the “OK” button to submit the encoded unique identifier for the POS to the back-end.

Upon receiving the mobile application check-in, the back-end performs a lookup of the submitted POS to identify the merchant associated with that POS. Additional information about the merchant can also be obtained by the back-end. The lookup is performed against a back-end database which stores the POS's registered by various merchants. The back-end then sends the merchant information to the mobile application and the mobile application displays the merchant information so that the user can confirm the check-in is correct.

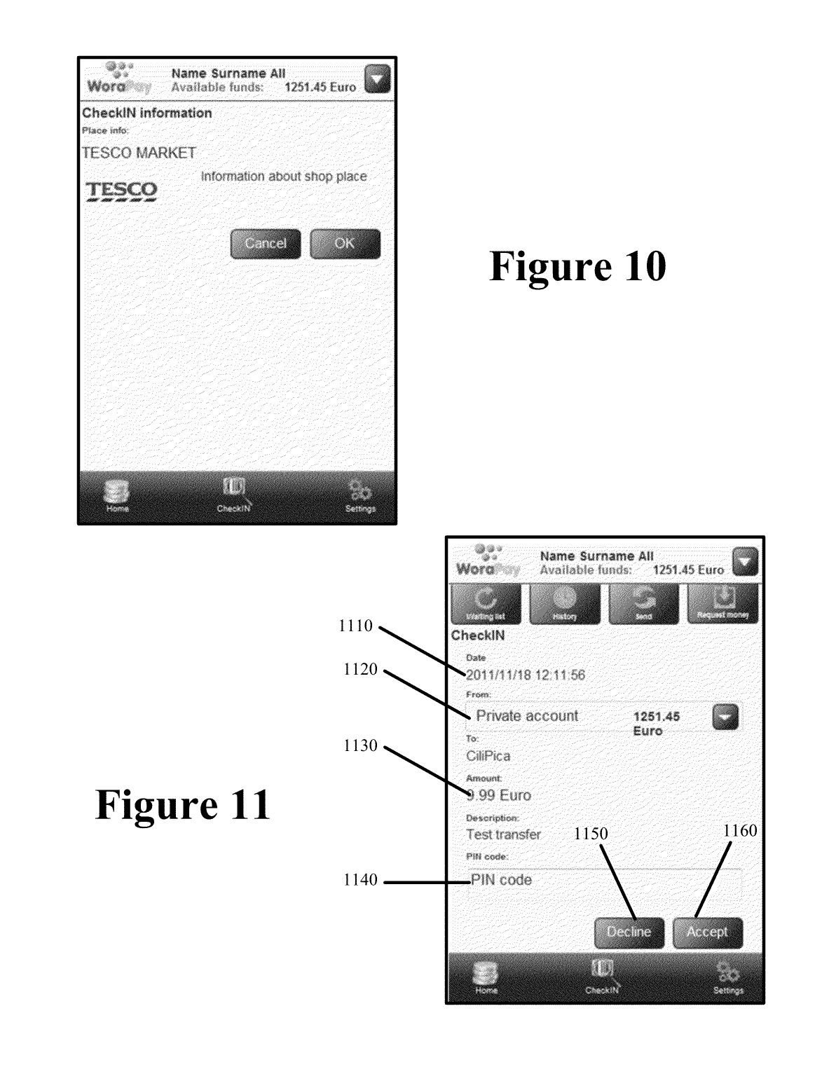

FIG. 10 presents a check-in confirmation interface in accordance with some embodiments. As shown, the interface identifies the merchant that is associated with the encoded unique identifier submitted during the check-in. This includes displaying the merchant name as well as optional information such as the merchant address, logo, etc. The user has the option confirm or decline the check-in. Should the user confirm the check-in, the back-end logs the check-in by associating the check-in to a profile of the identified merchant.

At the completion of the user check-in, the mobile application is directed back to the home interface. When the merchant uploads an invoice for the user check-in, the back-end will push that invoice to the mobile application and the mobile application will display the invoice as a pending transaction on the home interface. The home interface displays summary information for the pending transaction, wherein the summary information is populated with the amount due and an identifier for the merchant from the invoice. To pay for and complete the transaction, the user selects the graphical element for the pending transaction from the home interface. In so doing, the mobile application changes the interface to provide a detailed view of the pending transaction with an option to confirm and pay for the transaction.

FIG. 11 illustrates an exemplary detailed transaction interface for a Check-In transaction in accordance with some embodiments. The detailed transaction interface provides a timestamp for the transaction 1110, an account selection element 1120, the invoice amount 1130, optional transaction details, PIN entry interface 1140, and buttons 1150 and 1160 to confirm or decline the transaction.

Once the user has reviewed the transaction details and confirmed its accuracy and amount, the user selects the account from which to submit payment using the account selection element 1120. Next, the user enters his/her PIN in the entry box 1140 and selects the “Accept” button 1160. The information is then passed from the mobile application to the back-end. The back-end confirms that the PIN is correct and transfers the funds from the user account to the merchant account.

D. Send Interface

In addition to the “Check-In” transaction type, the payment system also supports external transaction types. External transactions mirror traditional wire transferring of funds albeit through a more secure system. The user can initiate a transfer of funds to any other registered profile of the payment system using the mobile application. To do so, the user invokes the “Send” element 730 on the home interface of the mobile application. In so doing, the mobile application displays the external transaction generation interface.

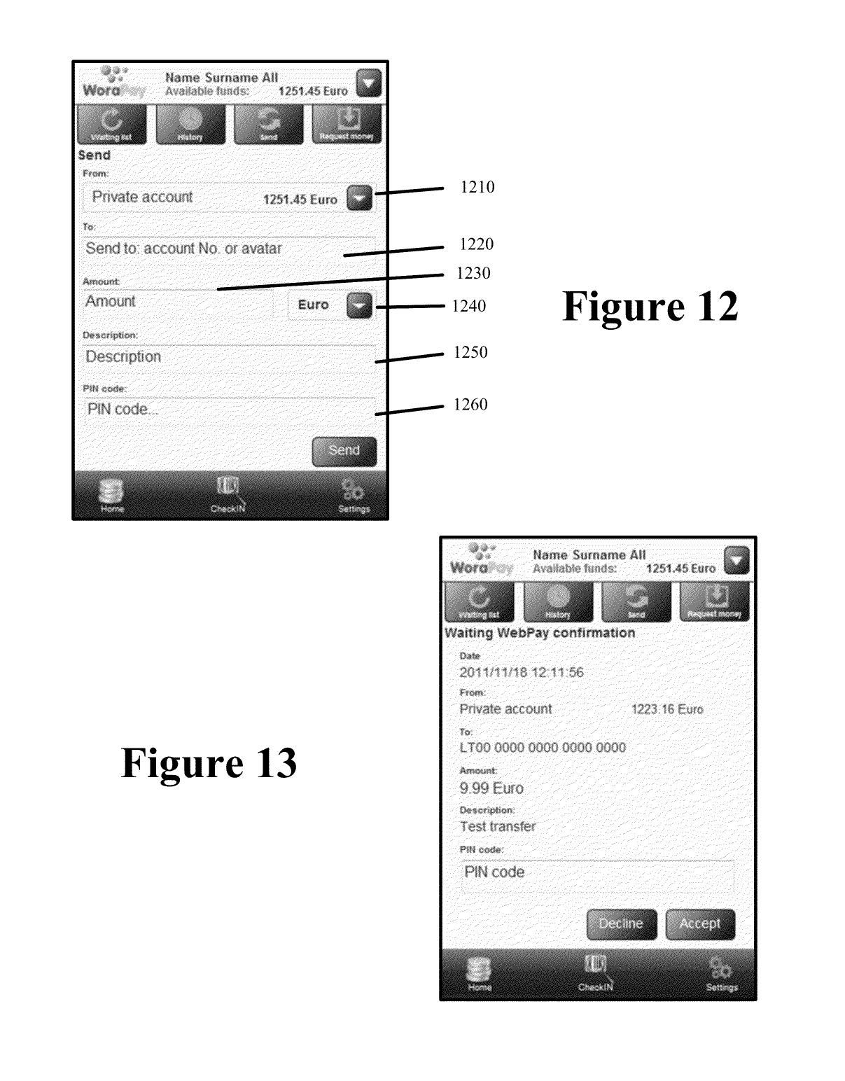

FIG. 12 presents an exemplary external transaction generation interface. As shown, this interface provides an account selection element 1210 and input fields 1220, 1230, 1240, 1250, and 1260. Using the account selection element 1210, the user selects one of his/her accounts that funds are to be transferred from. The balance of the selected account is shown. The input field 1220 receives identification information for the recipient of the funds transfer. The identification information of the recipient can be specified using a name, avatar, or account number of the recipient. The input field 1230 receives an amount to be transferred. The input field 1240 identifies the currency type. The input field 1250 provides a description for the transfer. The input field 1260 receives the PIN that authorizes the transfer from the user account. Upon entering the requested information in to the interface of FIG. 12 and invoking the “send” button, the information is transferred from the mobile application to the back-end. The back-end then wires the funds from the selected account of the user to the account of the recipient. When the transfer is complete, the back-end provides confirmation to the mobile application that the mobile application then displays.

E. WebPay Interface

The “WebPay” transaction is another type of transaction that is supported by the payment system and one that enables transactions to be completed across e-commerce type websites.

To initiate a WebPay transaction, a user accesses a merchant e-commerce website whereby goods and services can be purchased online. While navigating the merchant e-commerce website, the user selects goods and services to purchase. The selected goods and services are placed in an online shopping cart until the user is ready to checkout. When checking out, the e-commerce website will provide a new WebPay payment option in addition to or instead of credit card or Paypal payment options.

In some embodiments, the WebPay payment option is selected when the user invokes a button that is displayed on the merchant website, and more specifically, when the user invokes a button that is displayed on an e-commerce checkout website of the merchant. The WebPay payment option can also be selected using a drop down box or other interactive element on the merchant website.

Selecting the WebPay payment option from the merchant e-commerce site causes a script that interfaces with the back-end of the payment system to execute. The script presents an interface for the user to enter his name, avatar, email address, or other identifier that identifies the user's profile on the payment system. Once entered, the script causes a payment request for the purchased goods and services to be entered to the user's profile. Specifically, the script passes the requested payment information from the merchant website to the back-end. The back-end then generates a WebPay transaction that it then enters in the home interface of the mobile application registered to the user profile. In some embodiments, the script automatically populates a balance for the WebPay transaction based on a balance that appears on the merchant e-commerce website at the time of checkout. The script may also scrape identifying information about the goods and services being purchased from the merchant e-commerce website and populate that information as part of the WebPay transaction.

When the user selects the WebPay transaction from the home interface using the mobile application, the mobile application displays details regarding the payment request and provides the user with the option to accept the transaction and pay the specified amount or to decline the transaction. FIG. 13 presents an exemplary WebPay transaction interface for accepting or declining an online transaction using the mobile application in accordance with some embodiments. To pay for the transaction, the user selects a payment account that is linked to the user profile and the user enters the PIN for the selected payment account in order to transfer the requested funds from the user selected payment account to an account of the merchant.

In this manner, the user can pay for an online transaction without having to enter payment information (e.g., a credit card number) to the merchant website. Instead, the payment system brokers the transfer of funds. In so doing, all payment information is retained on the mobile application and with the payment system as opposed to distributing that information to each online merchant that one engages in transactions with.

In some embodiments, the back-end automatically generates the scripts for the various merchant that desire the WebPay payment option. To generate the script, the merchant logs in to his/her profile and submits a request for the WebPay payment option. The back-end can then generate the script for the merchant based on the available merchant information that is already populated as part of the merchant's profile. In some embodiments, additional information may be requested from the merchant, such as the URL for the e-commerce site of the merchant. The merchant then embeds that code within its checkout website.

F. Request Money

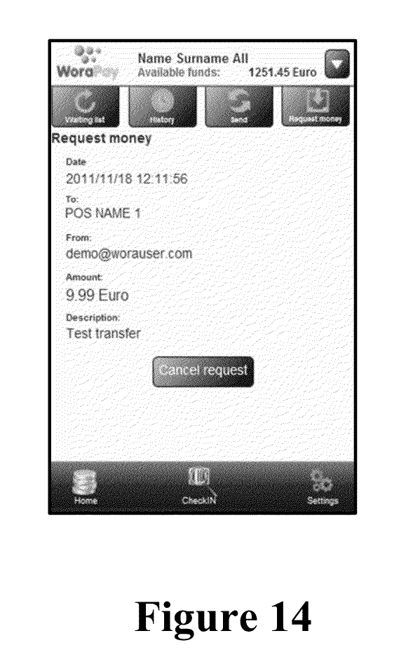

The “Request Money” transaction is yet another type of transaction that is supported by the payment system and one that can be conducted using the mobile application. This type of transaction allows a user or merchant to request money from other participants in the payment system. FIG. 14 illustrates an interface with which to request money from other participants using the mobile application in accordance with some embodiments. The user identifies who the funds are to be requested from, a requested amount, and a description to identify the reasons for the request. When the request is submitted, it is placed in the pending list of transaction of the recipient.

In some embodiments, the recipient pulls up the request using the mobile application running on the recipient's mobile device. The recipient can then confirm or decline the request. The recipient confirms the request by entering his/her PIN. When the recipient enters the PIN, the back-end commences the transfer of the specified funds from the recipient's account and deposits the funds in the account of the requesting user.

In some embodiments, the transaction is also entered in the home page of the requestor. The transaction can then be completed on the requestor's mobile device by handing the device to the recipient and allowing the recipient to enter the necessary information to complete the transaction. This functionality allows a merchant to complete a transaction with a customer when the customer forgets his/her mobile device and does not have a separate instance of the mobile application running. The subsection “Merchant Mobile Application” under the section “Merchant Interactions” below provides a more detailed description for the usage of the “Request Money” option.

G. Shared Profile

Some embodiments allow for accounts to be shared between different registered users and merchants. As one example, sharing of accounts allows family members or employees of a business to have access to a single account while having separate user profiles. The different entities can then perform separate transactions on that single account. Though each transaction is withdrawn from that single account, the payment system tracks which user performed the transaction based on the user's profile.

To share an account, a user logs in to his/her user profile. The user selects at least one account that is linked to the user profile and changes the settings of the selected account to make it shareable with other users. Next, the user specifies which other users to share the account with by providing the name, avatar, or other identifier (e.g., email address) for the other users of the payment system. The user then specifies the access permissions that the other users are provided to the shared account. The user can restrict the sharing by specifying only view permissions or specifying rights to conduct transactions on that account.

When the only view share option is specified, the back-end of the payment system applies the specified share permission to the account and updates the profile of the other users that the account is now shared with such that the other users can view the shared account from their user profiles. A notification may be sent to the other users' profiles or mobile applications to alert the other users of the access to the shared account.

The only view share option is useful when one acts in a supervisory or administrative role on the account of another. This allows the supervisor or administrator to monitor the transactions performed by another.

When permitting the other user to make transactions from the account, the sharing user can nevertheless restrict access of the other user by specifying a spending limit. A maximum spending limit can be specified per shared user or for a group of shared users. The maximum spending limit specifies a total amount that a user can withdraw from the shared account. Some embodiments also provide a “limit per period” which specifies a total amount that a user can withdraw from the shared account during a given time cycle. Here again, the payment system back-end applies the share permission to the account and updates the profile of the other user such that the other user can now make transactions from the shared account in accordance with the specified limits. A notification may be sent to the other user's profile or mobile application to alert the other user of the access to the shared account.

Account sharing is supported by the back-end. The back-end creates the proper links between the shared account and the user profiles of the users that are permitted access to the account. Once the link association is complete, the back-end sets the access permissions that each user has to the shared profile according to the access permissions specified by the user that primarily controls the shared account. The links and access permissions are typically stored to the payment system database which also stores the user profile data.

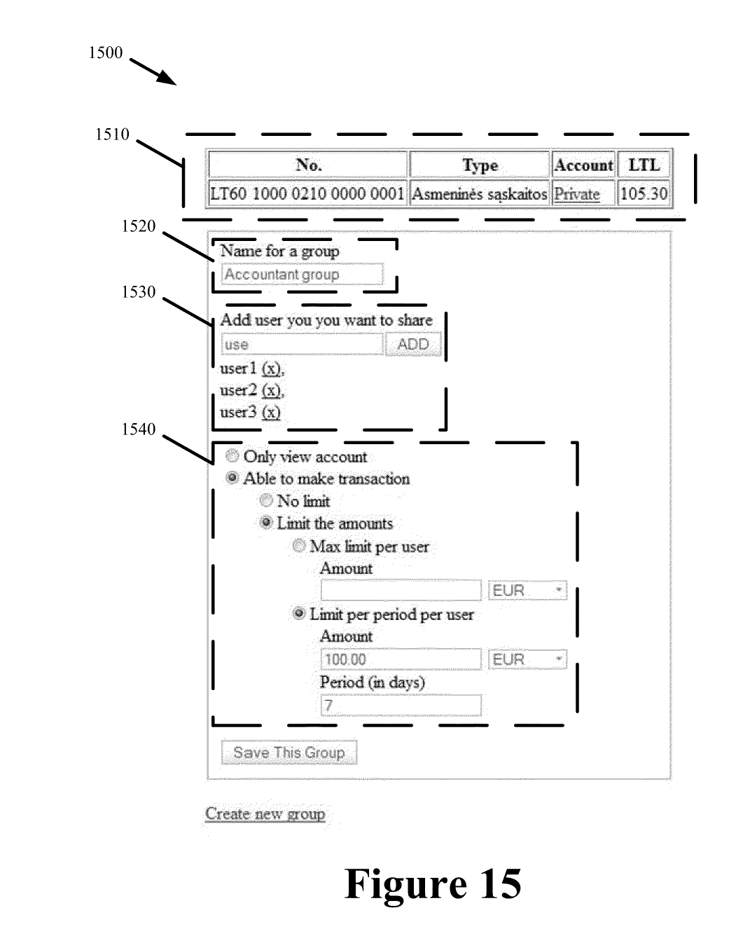

FIG. 15 presents an interface 1500 with which a user can specify other users to share an account with and the corresponding limits and restrictions placed on the shared account. Interface element 1510 specifies a selected account that is being shared. Interface element 1520 allows the sharing user to specify a name for the shared account. Interface element 1530 identifies the other users that the account is shared with and further allows the sharing user to modify who the account is shared with by adding users to or removing users from the shared account. Lastly, interface element 1540 specifies the access permissions that the other users have to the shared account.

### III. Merchant Interactions

A. POS

Merchants participate in the payment system by registering various POS's. Each POS represents a location in which the merchant can engage a user in a commercial transaction. A merchant can register a single POS when all transactions are completed at a single location. The merchant can also register multiple POS's when transactions are completed at different locations. The different locations can include different registers at a merchant store, different tables at a merchant restaurant, or different clients of the merchant as some examples.

Before registering a POS, a merchant registers itself with the payment system to create a business profile. Merchant registration is in many respects similar to user registration. The merchant directs a web browser of any network enabled device to the landing page hosted by the back-end of the payment system. If the merchant has a preexisting profile, the merchant enters the username and password that is associated with the profile to access the profile. Otherwise, the merchant invokes the “register” link to access the registration interface.

Using the registration interface, the merchant identifies itself as a business, enters identifying information, contact information, and secure login credentials (i.e., username and password). The payment system then directs the merchant to a profile home page. The profile home page displays any bank or payment accounts of the merchant that are linked to its profile. The profile home page for the merchant resembles the profile home page for the user, an example of which was provided with reference to FIG. 5 above.

A new profile registration will initially display with zero accounts. However, the merchant can link one or more bank or payment accounts to its profile from the profile home page. As before, linking an account includes providing account identifying information and optionally verifying access to the account, wherein identifying information may include the account number as well as other information including a routing number, bank name, bank address, and Swift code as some examples, and wherein verifying access to the account may involve the payment system depositing a small amount into the merchant account and having the merchant account identify the amount of the deposit.

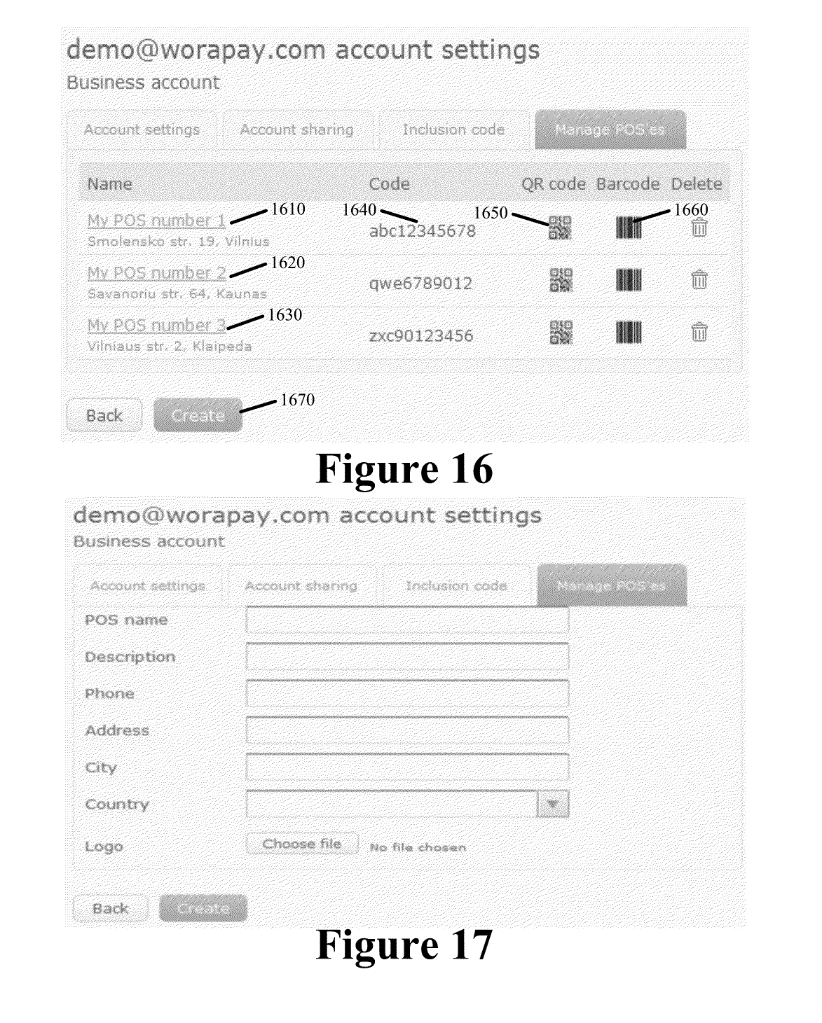

Once registered, the merchant establishes one or more POS's. The merchant does so through a “Manage POS” interface that is accessible from under the account settings, wherein the account setting is a link appearing on the profile home page. When selected, the Manage POS interface displays the existing POS's of the merchant while providing links for the merchant to add new POS's. FIG. 16 illustrates an exemplary interface for managing existing POS's and adding new POS's in accordance with some embodiments.

As shown, the interface displays the three POS's 1610, 1620, and 1630 already established by a merchant as well as the representations for the encoded unique identifiers generated for each POS. For example, POS 1610 includes a POS represented by alphanumeric value 1640, QR code 1650, and bar code 1660. Each of these POS's decodes to the same unique value. In other words, it does not matter if a user checks-in using the alphanumeric value 1640 or the QR code 1650, the back-end will identify the check-in as being performed at the same merchant POS.

To add a POS, the merchant selects the “Create” element 1670. This causes the interface to change and instead display a POS creation interface, an example of which is presented in FIG. 17. From this interface, the merchant can specify a name for the POS, a description, contact information, and a logo if desired. When the data fields are populated and the “Create” button is invoked, a query is submitted to the back-end for creation and registration of a new POS.

The back-end receives the entered data. The back-end generates an encoded unique identifier for the new POS based on the data. Specifically, the system ensures that the generated encoded unique identifier is unique from those of other registered POS's. Proprietary algorithms generate the unique encoded identifiers based on the merchant provided data. The back-end further generates the different POS representations for presenting the unique encoded identifier to users, wherein the representations include the alphanumeric value, bar code, and QR code as some examples. The back-end associates the unique encoded identifier and the POS representation with the merchant profile. The back-end also logs the unique encoded identifier and the different representations with the merchant data to a database.

The back-end passes the POS representations to the merchant via the POS management interface. With reference back to FIG. 16, the interface displays an icon for the bar code and QR code representations. The merchant can then select the bar code icon or QR code icon to bring a full scale image of the representation. The full scale image can then be printed and displayed as a POS of the merchant. In some embodiments, selecting the bar code icon or QR code icon opens an image or file (e.g., pdf) that the merchant can save and use later to print the representation.

To place a generated POS in service, the merchant prints and displays the POS (i.e., the encoded unique identifier) adjacent to a physical location of merchant. For example, if the merchant operates a restaurant with multiple tables at which the merchant conducts transactions with user, the merchant will display a different POS on each such table. Alternatively, a merchant that conducts transactions at user locations may require only a single POS for all user locations or may generate a different POS for each of its clients.

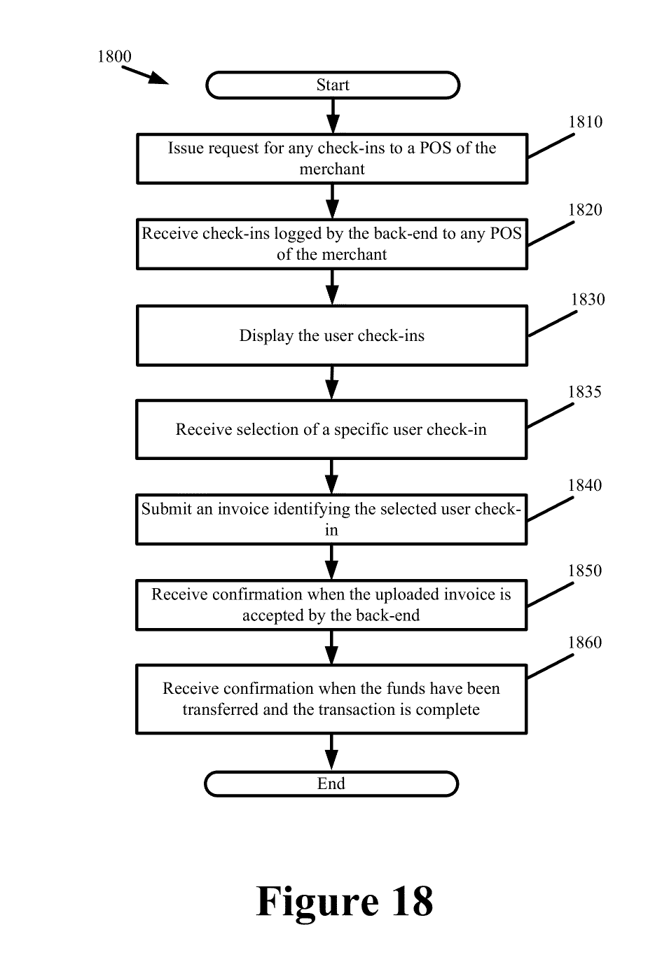

Once the merchant has established at least one POS, the merchant can submit invoices and request payments from any network enabled device using the web interface to the back-end. FIG. 18 presents a process 1800 by which a merchant invoices a user based on a check-in by the user to a POS of the merchant. The process 1800 begins by requesting (at 1810) the back-end to identify any check-ins to a POS of the merchant. Such a request is submitted when the merchant logs in to its profile or by requesting the information from the back-end when already logged in to the profile. The back-end identifies the merchant performing the request based on the merchant profile used to issue the request. The back-end then retrieves any check-ins that have been associated with the merchant profile.

The process receives (at 1820) the check-ins to any POS of the merchant and displays (at 1830) the check-ins to the merchant. The merchant can then select a particular check-in to invoice. Accordingly, the process identifies (at 1835) a particular check-in selection made by the merchant. The selection indicates that the merchant wishes to invoice the user that performed the selected check-in. The merchant can identify a specific checked-in user from other checked-in users based on the POS that the user checked-in with.

The process receives an invoice from the merchant and submits (at 1840) the invoice to the back-end. The invoice identifies the POS to which it pertains, an amount due, and may include details for the transaction. In some embodiments, the invoice is entered through a web interface.

The process receives (at 1850) confirmation when the uploaded invoice is accepted by the back-end. If rejected, the process can attempt resubmitting the invoice or change various details of the transaction or select a different check-in before resubmitting.

The process then awaits user payment. The process can include submitting additional requests for the user to complete the transaction and pay the amount due. When a user renders payment through the mobile application, the payment system acts as a clearing house by withdrawing funds from a selected bank account that is linked to the user profile and by depositing the funds to a selected bank account that is linked to the merchant profile. The process receives (at 1860) confirmation from the payment system when the funds have been transferred and the transaction is complete. The confirmation is displayed via a web interface, text or SMS message to a merchant telephone, or email to a merchant specified email address.

B. Merchant Mobile Application

The payment system provides several alternative methods by which merchants can complete transactions with users. These alternative methods can be used in addition to the above described methodologies utilizing the merchant POS's. In some embodiments, the alternative methods allow a transaction to be completed using a single network enabled device. These methodologies are preferred when, for example, the user or customer forgets to bring his mobile device that runs the mobile application, but the user nevertheless wishes to complete the transaction via the payment system herein described. In such instances, a “Request Money” transaction can be completed via an instance of the mobile application that runs on a network enabled device of the merchant. The “Request Money” transaction can also be completed using a modified credit card terminal or register of the merchant that supports the process 1900 below.

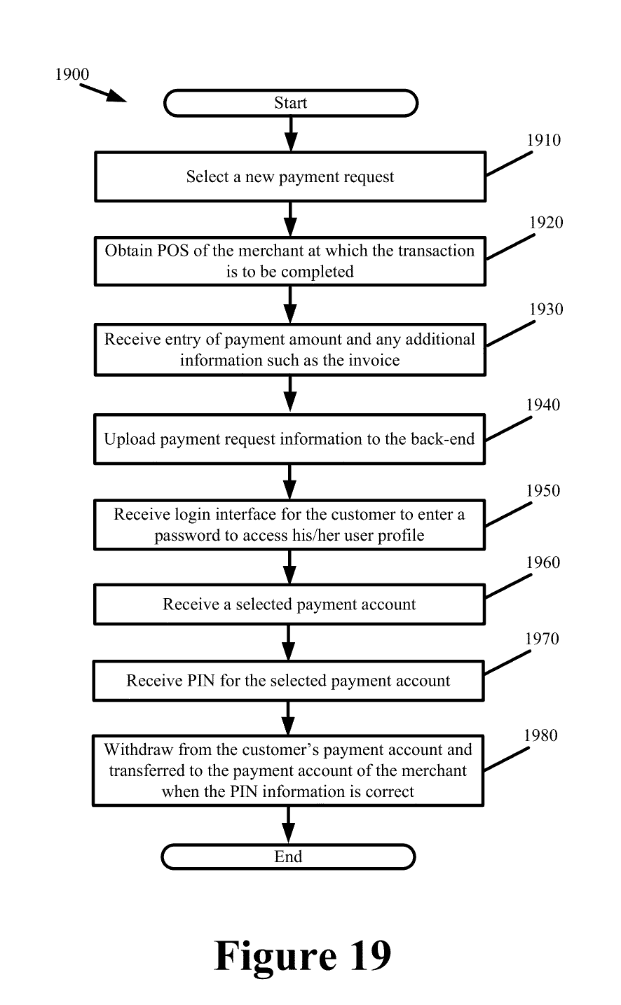

FIG. 19 presents a process 1900 for completing a “Request Money” transaction using an instance of the mobile application that runs on a network enabled device of a merchant in accordance with some embodiments. The process begins when the merchant instantiates the mobile application and selects (at 1910) a new payment request. The process then obtains (at 1920) a POS of the merchant at which the transaction is to be completed. For a merchant with a single POS, the process can be configured to automatically associate that POS with each transaction. For a merchant with multiple POS's, the process may involve the merchant manually entering the POS via an image or alphanumeric identifier or may involve the merchant selecting a POS from a previously entered list of POS's.

Next, the process involves entry (at 1930) of the payment amount and any additional information for the invoicing of the user. The process uploads (at 1940) the payment request information to the back-end. The back-end creates a payment request entry in the merchant profile. The back-end then instructs the merchant mobile application for user interactions. At this stage, the merchant hands the mobile application to the user in order for the user to complete the transaction.

The mobile application interface changes to present a login interface for the user to enter a password to access his/her user profile. The process receives (at 1950) the login information. The login information is passed to the back-end which then accesses the user profile associated with that login. The back-end also enters the merchant payment request to the user profile.

Once the login is complete, the process presents a selection interface with which the customer selects a payment account that is linked to the user profile to pay for the transaction. The process receives (at 1960) the payment account selection. Lastly, the process presents a PIN entry interface with which the user enters the PIN to authorize and pay for the transaction using the selected payment account. The process receives (at 1970) the PIN for the selected payment account. The information is then passed to the back-end which attempts to authorize and pay for the transaction. If the entered information is correct, the back-end withdraws (at 1980) the specified funds from the customer's payment account and transfers them to the payment account of the merchant. If incorrect, the customer is again requested to enter the PIN.

As should be evident from the above description, the payment system allows transactions to be completed through a single device, whereby completing the transaction nevertheless involves the concerted action of the merchant and the customer. In some such embodiments, the customer need not carry his mobile device with him at all times and can still be able to complete transactions by withdrawing funds from his linked payment accounts using a network enabled device provided by the merchant. Some such embodiments reduce the interaction needed from the customer and shift more of the actions to the merchant. Specifically, the merchant now performs the check-in on behalf of the user.

C. Merchant Payment Button

In some embodiments, the payment system functionality is integrated with existing payment terminals or registers of a merchant. In some such embodiments, the merchant enters goods and services purchased by a user to a register as normal. For example, the merchant scans UPC codes for goods and services at the register and the register keeps a tally of the total goods and services purchased. The user then accesses a modified payment terminal of the merchant that is linked to the register to complete the transaction. The payment terminal can be a modified credit card terminal, wherein the modified credit card terminal includes a card reader, a processor, network connectivity, and a display. The payment terminal is modified to provide a new payment option that utilizes the payment system of some embodiments to complete the transaction. The new payment option can be displayed along with traditional payment options such as payment via credit card or debit card.

When the user selects the new payment option, the user is then asked for an identifier by which the payment system profile of the user can be identified. In some embodiments, the identifier is the name, avatar, or email address that is associated with the user profile. In some embodiments, the identifier is the login credentials (e.g., username and password) to the user profile. The modified terminal passes the identifier along with a payment request to the payment system back-end. The payment request is automatically generated based on the purchased goods and services that were entered to the merchant register. In some embodiments, the payment request specifies an amount due to complete the transaction and merchant identifying information. The payment request may also specify a detailed listing of the transaction goods and services.

The back-end then enters the payment request to the identified user profile, wherein entering the payment request to the customer profile causes the payment request to appear on the home page of the user's mobile application. The user can then complete the transaction by accessing the mobile application, selecting the payment request for the transaction from the home page, selecting a payment account to pay for the transaction, and entering the PIN that authorizes payment from the selected payment account.

In some embodiments, the payment system back-end allows payment for the transaction to be rendered entirely through the modified terminal. In some such embodiments, the payment system back-end identifies the user profile and payment accounts linked to the profile. The back-end then selects a default payment account and requests the user to enter the PIN via the modified terminal, similar to how the user would enter a PIN for a debit card transaction. If the PIN for the default payment account is correctly entered, the back-end transfers funds from the default payment account of the user to a payment account of the merchant, thereby completing the transaction. Alternatively, the back-end can present the payment accounts linked to the user profile through the modified terminal. The user can then select a linked payment account and provide a PIN for the selected payment account to complete the transaction.

### IV. Back-End

In some embodiments, the back-end is a centralized or distributed set of servers. The back-end facilitates the interworking between the various users, merchants, and banks. This interworking enables the secure transfer of funds between parties to a transaction. The interworking further enables the back-end to serve as a clearing house that users and merchants authorize to credit and debit funds from their bank or payment accounts.

In some embodiments, the back-end gains access to the user and merchant accounts that are linked to the corresponding profiles by communicably coupling with the institutions that host the accounts. Conceptually, the back-end emulates the function of a bank and is permitted to credit and debit funds to the user and merchant accounts based on the account information provided by the users and merchants. The back-end is communicably coupled to users, merchants, and banks via a digital network such as the Internet. The connections between the back-end and each of the users, merchants, and banks are encrypted for security reasons.

To establish the interworking, the back-end performs and stores the profile registration on behalf of users and merchants while also performing POS creation and ensuring uniqueness of the POS's. This information is stored to a secure back-end database.

The registration and transaction functions of the back-end are enabled by one or more Application Programming Interfaces (APIs). These APIs define the commands and data structures passed between web browsers and the back-end for user and merchant profile registration. These APIs also define the commands and data structures passed between the mobile application, merchant web interface, and back-end to initiate and complete a transaction. Lastly, these APIs define the commands and data structures passed between the back-end and the various account institutions (e.g., banks) to facilitate the transfer of funds between accounts of various registered users and merchants. The commands and data structures are passed across existing wired and wireless networks using Internet messaging protocols.

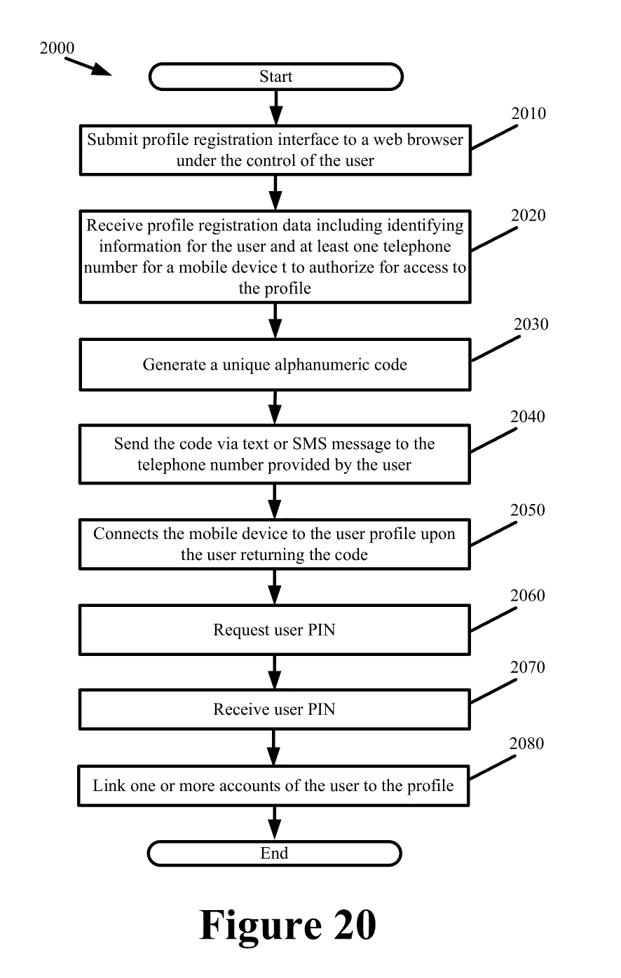

FIG. 20 presents a process 2000 performed by the back-end to register a user profile in accordance with some embodiments. The process 2000 begins by submitting (at 2010) the profile registration interface to a web browser under the control of the user. The process receives (at 2020) the profile registration data including the identifying information for the user and at least one telephone number for a mobile device that the user wishes to authorize for access to the profile. The process generates (at 2030) a unique alphanumeric code and sends (at 2040) the code via text or SMS message to the telephone number provided by the user. The process connects (at 2050) the mobile device to the user profile upon the user returning the code to back-end. Next, The process request (at 2060) and receives (at 2070) a user PIN. This PIN is used to confirm payment for a transaction. The process next links (at 2080) one or more accounts of the user to the profile to complete the user registration.

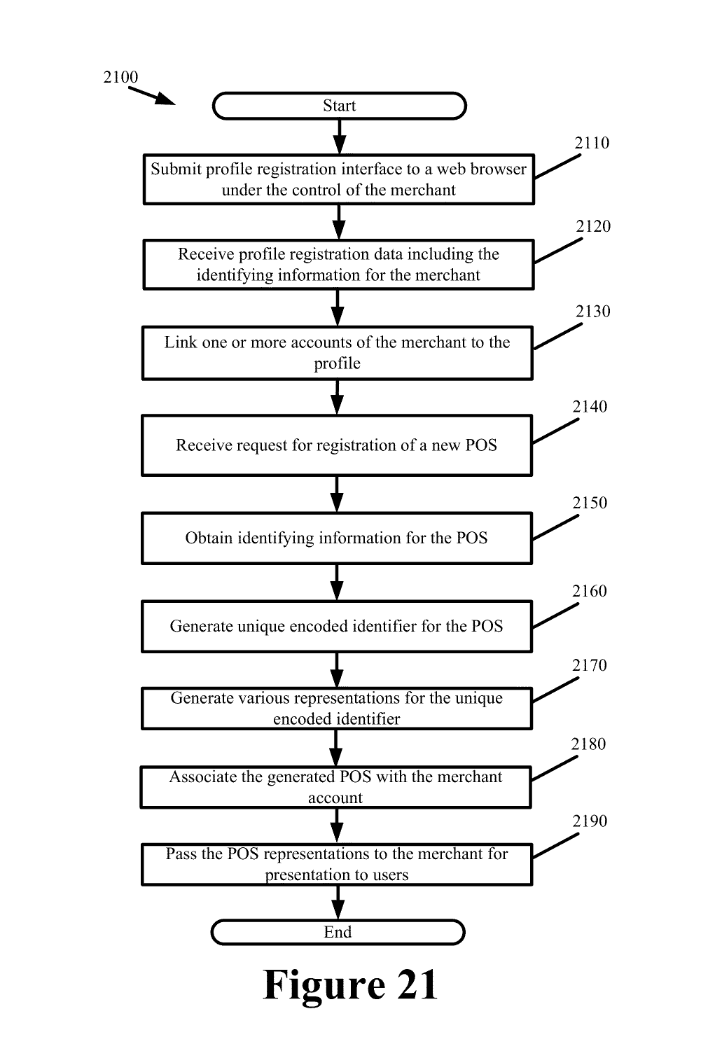

FIG. 21 presents a process 2100 performed by the back-end to register a merchant profile in accordance with some embodiments. The process 2100 begins by submitting (at 2110) the profile registration interface to a web browser under the control of the merchant. The process receives (at 2120) the profile registration data including the identifying information for the merchant. The process next links (at 2130) one or more accounts of the merchant to the profile. The process receives (at 2140) a request from the merchant for registration of a new POS. The process obtains (at 2150) identifying information for the POS. The process generates (at 2160) a unique encoded identifier for the POS. The process also generates (at 2170) various representations for the unique encoded identifier. The process associates (at 2180) the generated POS with the merchant account and passes (at 2190) the POS representations to the merchant for presentation to users.

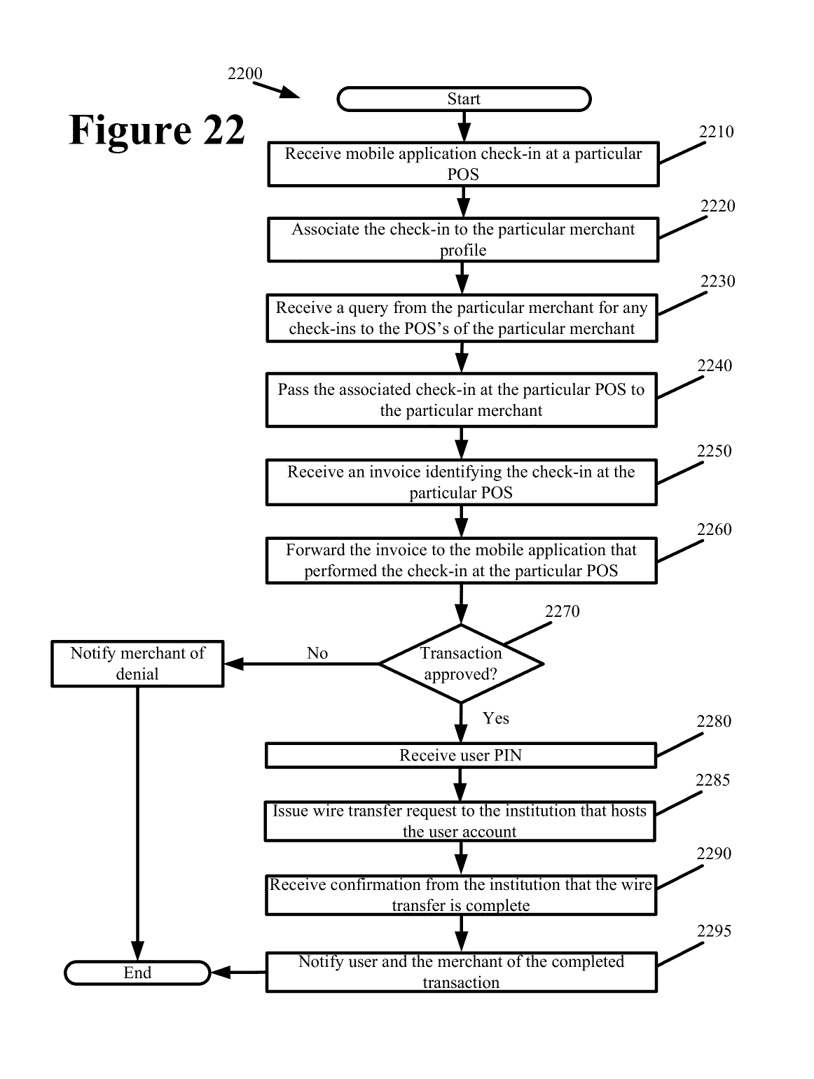

FIG. 22 presents a process 2200 performed by the back-end to complete a transaction in accordance with some embodiments. The process begins when the back-end receives (at 2210) a mobile application check-in at a particular POS. The process identifies the particular merchant to which the POS is registered and associates (at 2220) the check-in to the particular merchant profile. As part of associated the check-in to the particular merchant profile, the process also logs an identifier for contacting the mobile application that performed the check-in. This identifier can include an IP address of the mobile application.

The process receives (at 2230) a query from the particular merchant for any check-ins to the POS's of the particular merchant. The process passes (at 2240) the associated check-in at the particular POS to the particular merchant. The process receives (at 2250) an invoice identifying the check-in at the particular POS. The process forwards (at 2260) the invoice to the mobile application that performed the check-in at the particular POS. The process determines (at 2270) if the user approves or declines the transaction. When the transaction is declines, the process notifies (at 2275) the merchant. When the transaction is approved, the process receives (at 2280) the user PIN that authorizes payment. The back-end then issues (at 2285) a wire transfer request to the institution that hosts the user account. The request wire transfer request identifies the invoice amount, the account information of the user account from which the funds are to be withdrawn, and the account information for the merchant to which the funds are to be deposited. When the process receives (at 2290) confirmation from the institution that the wire transfer is complete, the process notifies (at 2295) both the user and the merchant of the completed transaction. In some embodiments, the back-end also records the completed transaction to the database so that it may be presented as part of the transaction history of the user and the merchant.

### V. System Servers

Many of the above-described processes and components are implemented as software processes that are specified as a set of instructions recorded on non-transitory computer readable storage medium (also referred to as computer readable medium). When these instructions are executed by one or more computational element(s) (such as processors or other computational elements like ASICs and FPGAs), they cause the computational element(s) to perform the actions indicated in the instructions. Server, computer, and computing machine are meant in their broadest sense and may include any electronic device with a processor that executes instructions stored on computer readable media or that are obtained remotely over a network connection. Examples of computer readable media include, but are not limited to, CD-ROMs, flash drives, RAM chips, hard drives, EPROMs, etc. Further, wherever a server is identified as a component of the embodied invention, it is understood that the server may be a single physical machine, or a cluster of multiple physical machines performing related functions, or virtualized servers co-resident on a single physical machine, or various combinations of the above.

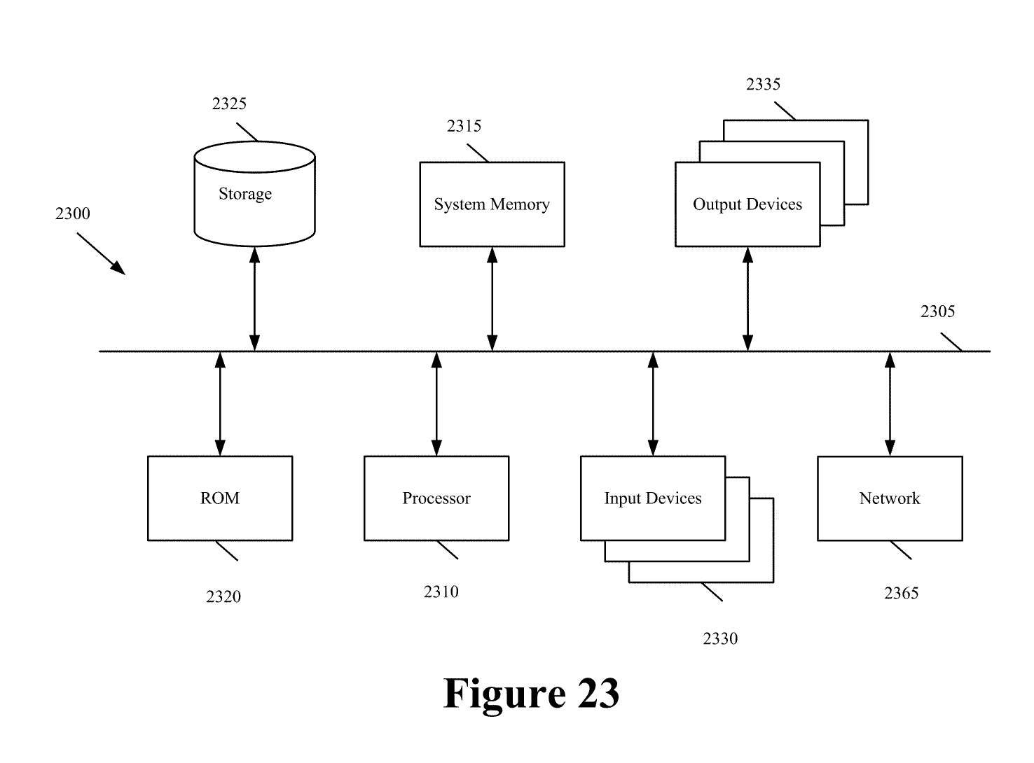

FIG. 23 illustrates a computer system or server with which some embodiments are implemented. Such a computer system includes various types of computer readable mediums and interfaces for various other types of computer-readable mediums that implement the system and methods described above (e.g., the back-end servers, mobile devices, mobile applications, etc.). Computer system 2300 includes a bus 2305, a processor 2310, a system memory 2315, a read-only memory 2320, a permanent storage device 2325, input devices 2330, and output devices 2335.

The bus 2305 collectively represents all system, peripheral, and chipset buses that communicatively connect the numerous internal devices of the computer system 2300. For instance, the bus 2305 communicatively connects the processor 2310 with the read-only memory 2320, the system memory 2315, and the permanent storage device 2325. From these various memory units, the processor 2310 retrieves instructions to execute and data to process in order to execute the processes of the invention. The processor 2310 is a processing device such as a central processing unit, integrated circuit, graphical processing unit, etc.

The read-only-memory (ROM) 2320 stores static data and instructions that are needed by the processor 2310 and other modules of the computer system. The permanent storage device 2325, on the other hand, is a read-and-write memory device. This device is a non-volatile memory unit that stores instructions and data even when the computer system 2300 is off. Some embodiments of the invention use a mass-storage device (such as a magnetic or optical disk and its corresponding disk drive) as the permanent storage device 2325.

Other embodiments use a removable storage device (such as a flash drive) as the permanent storage device Like the permanent storage device 2325, the system memory 2315 is a read-and-write memory device. However, unlike the storage device 2325, the system memory is a volatile read-and-write memory, such as random access memory (RAM). The system memory stores some of the instructions and data that the processor needs at runtime. In some embodiments, the processes are stored in the system memory 2315, the permanent storage device 2325, and/or the read-only memory 2320.

The bus 2305 also connects to the input and output devices 2330 and 2335. The input devices enable the user to communicate information and select commands to the computer system. The input devices 2330 include, but are not limited to, alphanumeric keypads (including physical keyboards and touchscreen keyboards) and pointing devices (also called “cursor control devices”). The input devices 2330 also include audio input devices (e.g., microphones, MIDI musical instruments, etc.). The output devices 2335 display images generated by the computer system. The output devices include, but are not limited to, printers and display devices, such as cathode ray tubes (CRT) or liquid crystal displays (LCD).

Finally, as shown in FIG. 23, bus 2305 also couples computer 2300 to a network 2365 through a network adapter (not shown). In this manner, the computer can be a part of a network of computers (such as a local area network (“LAN”), a wide area network (“WAN”), or an Intranet, or a network of networks, such as the Internet.

As mentioned above, the computer system 2300 may include one or more of a variety of different computer-readable media. Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ZIP® disks, read-only and recordable blu-ray discs, any other optical or magnetic media, and floppy disks.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

I claim:

1. A payment system comprising:
a plurality of encoded identifiers for display at a plurality of merchant locations, each encoded identifier of the plurality of encoded identifiers uniquely identifying a different Point-of-Sale (POS) of one of a plurality of merchants;
a mobile application linked to at least one payment account of a user, the mobile application (i) checking-in the user at a particular POS of a particular merchant by submitting to the payment system, a particular encoded identifier uniquely identifying the particular POS and (ii) providing a payment function enabling the user to approve and decline a payment request for a transaction that the particular merchant associates to the check-in at the particular POS;
a merchant interface (i) presenting any check-ins to a POS of the particular merchant and (ii) associating the payment request to the check-in performed by the mobile application at the particular POS; and
a back-end (i) generating at least one displayable representation for each encoded identifier of the plurality of encoded identifiers, (ii) passing the payment request for the transaction at the particular POS from the merchant interface to the mobile application, and (iii) transferring funds specified in the payment request from the at least one payment account of the user to a payment account of the merchant when the payment request is approved by the user using the payment function of the mobile application.

2. The payment system of claim 1, wherein the mobile application operates on a mobile device of the user, the mobile device comprising at least one of a smartphone, tablet, and laptop computer.

3. The payment system of claim 1, wherein providing the payment function comprises providing a Personal Identification Number (PIN) entry interface for the user to specify a PIN number to approve the payment request.

4. The payment system of claim 1, wherein the back-end further (iv) communicably couples to a first banking institution hosting the payment account of the user and a second banking institution hosting the payment account of the merchant to facilitate the transferring of funds between the payment accounts.

5. The payment system of claim 1, the mobile application further presenting pending payment requests that are associated with previous check-ins performed by the mobile application at other POS's.

6. A computer-implemented method for facilitating payments via a mobile device, the computer-implemented method comprising:
receiving from a mobile application running on the mobile device, a check-in of the mobile application at a particular Point-of-Sale (POS) of a merchant, the check-in comprising an identifier uniquely associated with the particular POS;
registering the check-in of the mobile application at the particular POS in a database, said database storing check-ins of other mobile applications at other POS's of other merchants;
receiving from the merchant, a payment request specifying the identifier of the particular POS;
submitting the payment request to the mobile application that performed the check-in at the particular POS;
receiving a response to the payment request from the mobile application;
transferring funds specified in the payment request from a payment account linked to the mobile application to a payment account of the merchant when said response authorizes a withdrawal of the funds from the payment account linked to the mobile application.

7. The computer-implemented method of claim 6 further comprising matching the payment request to the mobile application check-in based on the identifier for the particular POS.

8. The computer-implemented method of claim 6 further comprising generating a plurality of identifiers for the merchant, each identifier of the plurality of identifiers uniquely identifying a different POS of the merchant.

9. The computer-implemented method of claim 8 further comprising generating at least one representation for presenting each of the plurality of identifiers at different POS's of the merchant.

10. The computer-implemented method of claim 8, wherein the plurality of identifiers is a first plurality of identifier and the merchant is a first merchant, the computer-implemented method further comprising generating a second plurality of identifiers to uniquely identify each of a plurality of POS's of a second merchant.

11. The computer-implemented method of claim 6, wherein said response authorizes a withdrawal of the funds when the response comprises a Personal Identification Number (PIN) for the payment account linked to the mobile application.

12. The computer-implemented method of claim 6 further comprising registering the mobile application with a mobile device assigned a specific telephone number.

13. The computer-implemented method of claim 12 further comprising verifying a login to the mobile application, wherein verifying the login comprises enabling access to the mobile application when the mobile application is run on the mobile device assigned the specific telephone number and disabling access to the mobile application when the mobile application is run on a mobile device not assigned the specific telephone number.

14. The computer-implemented method of claim 6, wherein the identifier is displayed adjacent to the particular POS and is represented by at least one of an alphanumeric value, a bar code, and a QR code.

15. A computer-implemented method for facilitating electronic payment of a transaction via a mobile device, the computer-implemented method comprising:
providing to each merchant of a plurality of merchants, at least one identifier uniquely identifying a POS of the merchant from other POS's of the merchant and other POS's of other merchants;
registering a profile for each user of a plurality of users, wherein registering a profile comprises (i) linking at least one payment account to the profile, (ii) specifying access credentials by which a mobile application can access the profile to check-in at a POS and to pay for a transaction conducted at that POS, and (iii) storing a PIN for confirming a transfer of funds from the at least one payment account when the mobile application is checked-in to a POS and approves payment for a transaction conducted at that POS;
tracking user check-ins to any of a plurality of POS's, wherein tracking a user check-in comprises entering to a database an identity of a mobile application that performs the check-in and an identifier for a POS at which the check-in occurs;
receiving an invoicing request from a particular merchant of the plurality of merchants;
presenting to the particular merchant, any user check-ins comprising an identifier for a POS of the particular merchant that are tracked to the database;
receiving (i) selection of a particular check-in at a particular POS of the particular merchant and (ii) a payment request for a transaction conducted at the particular POS; and
forwarding the payment request to a mobile application that performed the particular check-in at the particular POS;
transferring funds from a payment account that is linked to the profile of the mobile application that performed the check-in at the particular POS to a payment account of the particular merchant when the mobile application provides the PIN that is stored with the profile.

16. The computer-implemented method of claim 15 further comprising generating a displayable representation for each unique identifier, said displayable representation for display at a POS identified by the unique identifier.

17. The computer-implemented method of claim 15, wherein transferring funds comprises initiating a wire transfer for the funds from the payment account that is linked to the profile of the mobile application to the payment account of the particular merchant.

18. The computer-implemented method of claim 15 further comprising presenting to the mobile application, each transaction that is completed using the mobile application.

19. The computer-implemented method of claim 15 further comprising providing confirmation of a completed transaction to each of the mobile application that performed the check-in at the particular POS and the particular merchant when the funds transfer is complete.

20. The computer-implemented method of claim 15 further comprising declining the transfer of funds when the mobile application does not provide a valid PIN.
